(19) United States
(12) Patent Application Publication
(10) Pub. No.: US 2013/0064981 A1
(43) Pub. Date: Mar. 14, 2013

(54) METHOD FOR MAKING AN ABSORBER COATING FOR SOLAR HEATING, THE COATING AS SUCH AND ITS APPLICATION

(71) Applicants: Merete HALLENSTVET, Notteroy (NO); Bente Gilbu Tilset, Hvalstad (NO); Volker Denkmann, Kempen (DE); Andreas Siemen, Juchen (DE); Anita Lacau, Holmestrand (NO); Christian Simon, Oslo (NO); Axel Blecher, Niederkassel (DE); Wilhelm Schenkel, Grevenbroich (DE)

(72) Inventors: Merete HALLENSTVET, Notteroy (NO); Bente Gilbu Tilset, Hvalstad (NO); Volker Denkmann, Kempen (DE); Andreas Siemen, Juchen (DE); Anita Lacau, Holmestrand (NO); Christian Simon, Oslo (NO); Axel Blecher, Niederkassel (DE); Wilhelm Schenkel, Grevenbroich (DE)

(21) Appl. No.: 13/545,409

(22) Filed: Jul. 10, 2012

Related U.S. Application Data
(63) Continuation of application No. PCT/NO2011/000014, filed on Jan. 12, 2011.

(30) Foreign Application Priority Data
Jan. 13, 2010 (NO) 20100057

(51) Int. Cl. C09D 1/00

(52) U.S. Cl. CPC C09D 1/00
USPC 427/388.1; 427/372.2; 106/286.2; 524/403

(57) ABSTRACT

Method for making an absorber coating for solar heating and a coating as such to be applied on a metal substrate, in particular a coating to be applied on a thin aluminium metal sheet.

The coating is of the sol-gel type based on a metal oxide precursor where pigment particles are intimately mixed into the precursor followed by application of the mixed sol lacquer on the substrate and thereafter reaction in humid air at a required temperature to obtain the sol-gel coating.

The precursor may preferably be a CeO₂ (NO₃) based sol with preferably 20% CeO₂ having a particle size of 10-20 nm and a pH of 1.5. Further the pigment may be a manganese ferrite black spinel, Mn₃Cu₂FeO₈.

The present invention relates to a method for making an absorber coating for solar heating, in particular a coating to be applied on a thin aluminium metal sheet. The invention further includes a solar coating made by the method as well as the application of the coating.

Solar heating harnesses the power of the sun to provide solar thermal energy for different purposes such as solar hot water, solar space heating and solar pool heaters. A solar heating system saves energy, reduces utility costs, and produces clean energy. The efficiency and reliability of solar heating systems have increased dramatically, making them attractive options in connection with energy supply to private houses as well as in stores and office spaces.

Most solar water-heating systems for buildings have two main parts, namely a solar collector and a storage tank. Solar water heaters use the sun to heat either water or a heat-transfer fluid in the collector. Heated water is then held in the storage tank ready for use, with a conventional system providing additional heating as necessary. The tank can be a modified standard water heater, but it is usually larger and very well insulated. Solar water heating systems can be either active or passive, but the most common are active systems. The most common collector used in solar hot water systems is the flat plate collector. The present invention relates in particular to a coating for such flat sheet collector.

In a project under which the present invention was conceived, the inventors aimed to produce a sol-gel based coating applied in particular on aluminium substrate by a coil coating method and having the following properties:
High solar absorbance (0,28-2,5 μm), a≧95%
Low thermal emissivity (2,5-50 μm), e≦0,1.
Maximum possible surface temperature
Low viscosity, suitable for coil coating
Drying at 160-600° C. metal temperature.
Withstand 600° C. up to to 2 h
Withstand 400° C. for 100 h.
Lifetime stability at 230° C.
Stable against humidity.
Long term stability: Corrosion resistance in microclimate ISO CD 12952-2.

Presently different types of coatings for solar energy absorbing purposes are known in the market such as black paints with organic binder, or selective coatings prepared by CVD sputter type and sol-gel type coatings. Many of the known coating types do not, however, comply with the above requirements such as the requirement with regard to temperature and corrosion.

Sol-gel type coatings, in particular inorganic, are known to have variable and even poor adhesion properties. However, they are known to have chemical stability and thermal stability even at higher temperatures. Further advantages with these types of coatings are the modest requirement of equipment and easiness to apply the coating, low energy consumption and the possibility of combining different types of layers

From WO 2007/147399 is known a process for producing a solar absorbing coating comprising the steps of coating of a substrate with a titanium precursor solution to produce a titanium dioxide layer by the sol-gel technique and heat treating the substrate to pyrolysis and crystallize the layer and where silver ions are added to the titanium precursor solution prior to coating. This known solution does not, however, comply with the requirements as regards solar absorbance mentioned above.

With the present invention is provided a cost effective method for making an absorber coating for solar heating, as well as a coating as such which is made according to the method.

With the invention is further provided a method and coating where the above-mentioned requirements as regards solar absorbance, thermal emissivity, thermal stability and resistance etc. are to an acceptable or large extent fulfilled.

The method is characterized by the features as defined in the independent claim 1 and the coating as such is characterized by the feature as defined in the independent claim 7.

Dependent claims 2-6 and 8-13 define preferred embodiments of the invention.

The present invention will be further described in the following with way of examples and with reference ti the figures, where:

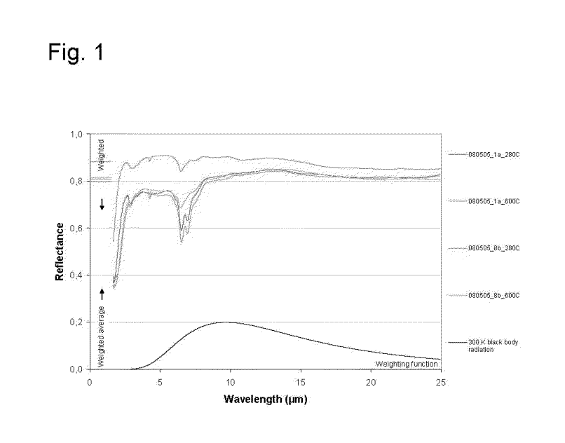

FIG. 1 IR spectrum of samples according to the invention coated with Manganese ferrite black spinell in CeO2 (NO3) sol on electrochemical degreased AA1050 substrate

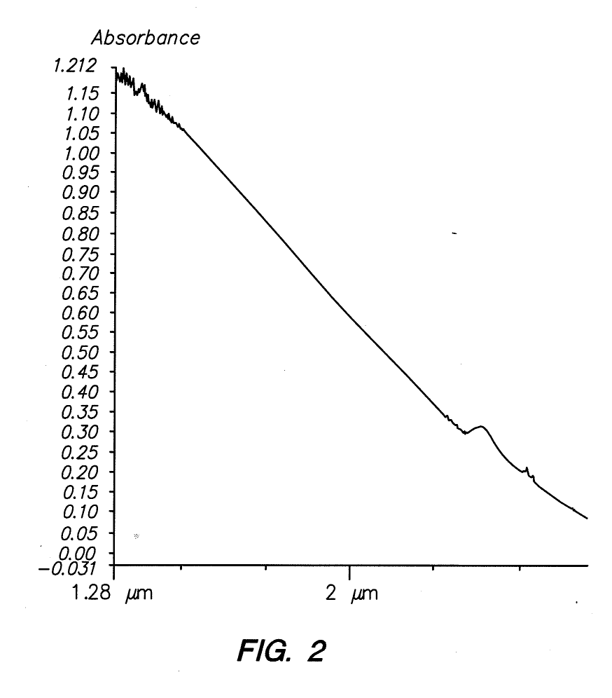

FIG. 2 Shows the IR spectrum of Manganese ferrite black spinell,

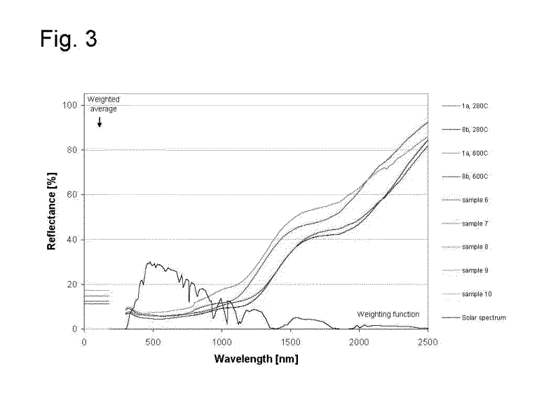

FIG. 3 shows UV-VIS-NIR spectra of samples coated with Manganese ferrite black spinell in CeO2 (NO3) sol on electrochemical degreased AA1050 substrate

In view of the above-mentioned requirements and previous experiences with coating preparations, the inventors initially decided to investigate inorganic coatings based on black inorganic pigments dispersed in a metal oxide sol such as CeO₂ based sol.

The IR spectrum of pure CeO₂ show no IR bands; thus it has low emissivity and should be suited as an inorganic binder for black, solar absorbing pigments. Introductory experiments showed that CeO₂ coatings performed well with respect to adhesion and scratch resistance after heating to 600° C. but for lower temperature applications ways of improving the adhesion has been investigated, either by organic or inorganic additive in the sol or by adhesion promotors on the passivation layer.

### Example 1

The following starting materials were used:
Ceria nitrate sol, with 10-30 wt % CeO₂, particle size 10-20 nm and pH=1.5
Black Pigment, Manganese ferrite black spinell with average particle size 0.5 μm and pH=6.0 when dispersed in water.

The pigment has a very low reflectance in the UV-VIS-NIR range. The composition was shown to be Mn₃Cu₂FeO₈ by SEM (EDS).
Organic additive, for improving adhesion after low temperature heat treatment (280° C.).

Different concentrations of the main ingredient were tested, see the result table.

Lacquer Preparation Procedures.

Good dispersion of the pigment in the sol is needed; preferably particle sizes ≦0.5 μm should be achieved. Foam formation should be avoided.

For introductory lab-scale samples, ultrasonic treatment was combined with stirring. The procedure giving the most stable dispersion was: 3×10 min ultrasonic horn treatment (instrument: Branson Sonifier 450) with magnetic stirring. Output was set to 7, with 50% duty cycle. The sample was standing in an ice bath to avoid overheating. Any foam formed was removed by gentle stirring, vacuum treatment and ultrasonic bath+slow (100 rpm) stirring over night

For practical reasons, ultrasonic treatment may not be used for industrial scale lacquers.

For industrial scale samples were produced based on conform laboratory procedure with the following modifications:
pigment wetting/dispersion was carried out in a high shear dispersing machine, adding 25-35% of the total amount of sol. Stirring time until particle size average 0,5 μm achieved.
organic additives were added
the formulation was completed with balance of sol.

Lacquer was prepared in a jet stream mixer, with very good dispersion properties and very low amount of foam during mixing.

Application Procedure for the Lab-Scale Samples:

Introductory experiments were performed on electrochemical degreased aluminium dip coated in the lab. Retraction rate: 1-10 mm/s; 3 mm/s was preferred.

After introductory experiments, samples were bar coated, using bars 4-22; bar 4 was preferred and the substrate electrochemical degreased.

Industrial line trials were performed using thin Al strip, coated continuously through a coil coating process. The first step after de-coiling was the pre-treatment section, which included electrochemical degreasing. The prepared solar coating (lacquer) was applied by deep feed in a three rollers system., where the applicator roller rotated reverse, the metering roller forward and the third roller reverse, related to the strip direction. The curing was carried out in a convention oven, with warm air circulation and temperature set up to achieve a PMT of minimum 280° C. Coated strip went through a cooling (air and water) unit after exit oven and re-winded again.

Heat Treatment of Lab Coated Samples.

After coating, the lab-coated samples were heated for 1 min in a furnace adjusted to 280° C. or 260° C. The peak metal temperature (PMT) was always >250° C. The samples were after heat treatment either cooled in air or in water. Some samples were heated a second time, in a furnace at 500 or 600° C. for 10 min. All furnaces had air as atmosphere.

Adhesion Tests.

Several test methods have been applied: crosshatch according to DIN EN 13523-6:2002 and bending tests according to DIN EN 13523-7:2001 and rub test:

Crosshatch Tape off: The adhesion was evaluated based on whether or not the tape pulled off the coating. Samples were graded on a scale from 1 to 4, where 1 was the best. To get a “1”, the glue from the tape must remain on the coating after pull-off. A sample graded “4” had very easy coating release—all the coating was on the tape, regardless of whether there was a crosshatch pattern or not.

A similar grading system was used for bending tests. The samples were folded and then opened—if the coating was intact and not rubbed off by using a finger afterwards, the grading was denoted “1”.

Rub test according to DIN EN 13523-11:2003 is performed by rubbing back and forth with a special roundel while applying a fixed pressure of 10 N. The number of double rubs before the coating is penetrated to show substrate material is measured. A good coating should withstand ≧50 rubs.

Optical Properties.

IR and UV-VIS-NIR spectra were used to characterize optical properties of the coated Al-surface.

The UV-VIS-NIR spectrum was weighted, using the solar spectrum, to obtain the total solar reflection (TSR) value. The solar absorption (α) is found from TSR: α=(100-TSR)/100

The IR spectrum was weighted, using black body radiation at 300 K, to obtain the emissivity (ε).

The solar efficiency (E) of the coating depends both on α and ε. The following two formulas were used:

E=α/ε 1)

E=α²/ε 2)

The validity of these formulas has so far not been confirmed experimentally.

Results.

There are two basic requirements to a solar coating for industrial use: high solar efficiency and good adhesion to the Al-substrate.

The results from the lab-scale and industrial scale tests as described above are shown in the below table 1.

TABLE 1

| Sample | | | | Adhesion | Adhesion |
|---|---|---|---|---|---|
| no. | Formulation | Emisivity | TSR | double rub | tape off |
| 1 | Sol + 12.4% Black | 0.03 | 16.93 | >20 | Low |
| | pigment, no | | | | |
| | additive | | | | |
| 2 | Sol + 12.4% Black | | | No | Low |
| | pigment, no | | | adhesion | |
| | additive | | | | |
| 3 | Sol + 12.4% Black | 0.11 | 16.26 | >20 | Low |
| | pigment + 10% | | | | |
| | Add2 | | | | |
| R4 | Sol + 10% Black | 0.14 | 13.56 | >50 | Good |
| | pigment + 10% | | | | |
| | Add2 | | | | |
| 5 | Sol + 10% Black | 0.08 | 18.38 | >50 | Good |
| | pigment + 5% | | | | |
| | Add2 | | | | |
| R15A | Sol + 8% Black | 0.13 | 18.41 | 100 | Good |
| | pigment + 7% Add. | | | | |
| R18 | Sol + 10% Black | 0.17 | 13.59 | 100 | Good |
| | pigment + 5% Add | | | | |
| R20 | Sol + 8% Black | 0.15 | 16.82 | 100 | Good |
| | pigment + 7% Add | | | | |
| 6 | 10% Black | 0.07 | 18.17 | >50 | lower than |
| | pigment + 1% | | | | no. 4 |
| | Add2 | | | | and 5 |
| F5 | Sol + 8% Black | 0.13 | 18.47 | >30 | Good |
| 90-50 | pigment + 7% Add. | | | | |
| | Industrial | | | | |
| | application | | | | |
| F5 | Sol + 8% Black | 0.15 | 16.09 | >30 | Good |
| 90-60 | pigment + 7% Add. | | | | |
| | Industrial | | | | |
| | application | | | | |
| 4 | 12.4% GV tynn + | 0.10 | 15.27 | >50 | Good |
| | 1% Add2 | | | | |

Samples F5 90-50 and F5 90-60 in Table 1 are related to the Industrial line trials, whereas all of the other samples are related to the lab-scale trials.

### Example 2

The adhesion of sol-gel coating to an aluminium substrate can be improved by preparing the aluminium surface with a tie layer between the sol-gel coating and the aluminium substrate. This tie layer can for example be a conversion coating or an inorganic silicate based primer, or a conversion coating/primer based on TiO₂.

The following starting materials were used:
CeO2(NO3) sol, with 20 wt % CeO₂, particle size 10-20 nm and pH=1.5
Black Pigment, Manganese ferrite black spinell with average particle size 0.5 μm and pH=6.0 when dispersed in water.

Lacquer preparation was done as in industrial scale described in example 1 above using a jet stream mixer.

Further, industrial line trials were performed as in example 1 above using thin Al strip, coated continuously through a coil coating process. The first step after de-coiling was the pre-treatment section. The prepared solar coating (lacquer) was applied by NIP feed in a three rollers system, where the applicator roller rotated reverse, the metering roller forward and the third roller reverse, related to the strip direction. The curing was carried out in a convention oven, with warm air circulation and temperature set up to achieve a PMT of minimum 280° C. Coated strip went through a cooling (air and water) unit after exit oven and re-winded again.

The same test methods as in example 1 were applied in this example.

TABEL 2
Adhesion and emissivity of different substrates

| | | | Pre- | Adhesion | | |
|---|---|---|---|---|---|---|
| Sample | Formulation | Alloy | treatment* | double rub | Emissivity | TSR |
| Lab 1 | Sol + 10% black | 3005 | Cr VI NR | <5 | 0.06 | |
| | pigment | | | | | |
| Lab 2 | Sol + 10% black | 1050 | ECD 3b | <20 | 0.05 | |
| | pigment | | | | | |
| Lab 3 | Sol + 10% black | 1050 | ECD 4b | <10 | 0.06 | |
| | pigment | | | | | |
| Lab 4 | Sol + 15% Black | 8011A 0.21 mm | Cr free Si | 50 | 0.11-0.17 | 7.33-7.47 |
| | pigment | | | | | |
| Lab 5 | Sol + 10% Black | 3005 | Cr VI NR | <10 | 0.06 | 30.34 |
| | pigment | | | | | |
| Line(BLA)3 | no | 3005 | Cr 3+ | n.a. | 0.09 | 23.05 |
| Line (A)4 | no | 1050 | ECD | n.a. | 0.03 | |
| Line(BLA)3 | no | 3005 | Cr free Si | n.a. | 0.03 | |

*ECD = Electro Chemical Degreasing Cr VI NR = No rinse chemical pre-treatment by chromating, hexavalent Chromium Cr free Si = Chromium free chemical pre-treatment, in presence of Silicium Cr 3+ = Chemical pre-treatment with trivalent Chromium

Optical Properties of Coated Samples.

Typical IR and UV-VIS-NIR spectra of coatings without organic adhesion promotor are shown in FIGS. 1 and 3, respectively.

An absorption band at 7 μm is detected in the IR range (FIG. 1) for all samples, with varying intensity. This feature is probably due to Ce(NO₃)₄, since the IR spectrum of Black pigment (FIG. 2) did not show any strong features in this region. Furthermore, the band intensity decreases after heating to 500° C. and 600° C., probably due to decomposition of Ce(NO₃)₄ to nitrous oxides and CeO₂.

In the UV-VIS-NIR range, rather indistinct features are seen (FIG. 2). As required, the absorption in the solar region is large, with a gradual development to high reflectance in the IR region.

The invention as defined in the claims is not restricted to the above examples. Thus, the additive which may be added to an mixed into the sol may be an acrylate- and styrocopolymer, a mixure of polyvinyl acetate polymer and -copolymer, polyvinyl acetate, polyvinyl alcohol, polyvinyl ether, polyurethane and/or polymetacrylathomo and -copolymer, acrylat dispersions, polyester.

Further, the coating may be based on a mixture of two sols where the second sol is a nano scaled Al₂O₃, SnO₂, Y₂O₃, ZnO or SiO₂ sol.

1-16. (canceled)

17. Method for making an absorber coating for solar heating to be applied on a metal substrate, in particular a coating to be applied on a thin aluminium sheet metal, wherein the coating is of the sol-gel type based on a metal oxide sol where pigment particles are intimately mixed into the sol followed by application of the mixed sol lacquer on the substrate and thereafter drying in air at an elevated temperature to obtain the sol-gel coating.

18. Method according to claim 17, wherein the coating is based on mixing of two sols.

19. Method according to claim 17, wherein the an organic additive is added and mixed into the sol lacquer immediately prior to application on the substrate.

20. Method according to claim 19, wherein the additive is an acrylate- and styrocopolymer, a mixure of polyvinyl acetate polymer and -copolymer, polyvinyl acetate, polyvinyl alcohol, polyvinyl ether, polyurethane and/or polymetacrylathomo and -copolymer, acrylat dispersions, polyester.

21. Method according to claim 17, wherein the drying takes place at a temperature between 180-600° C.

22. Method according to claim 17, wherein the substrate, after the drying at 180-6000C, is cooled in air or quenched to room temperature in water and thereafter is dried, reheated and held at a temperature of 300-6000C for at least 10 min

23. Method according to claim 17, wherein the sol lacquer is applied to the substrate by spraying, dipping or coil coating.

24. Coating for solar heating to be applied on a metal substrate, in particular a coating to be applied on a thin aluminium metal sheet, wherein the coating is of the sol-gel type based on a metal oxide sol and with pigment particles which are intimately mixed into the sol prior to application on the substrate.

25. Coating for solar heating according to claim 24, wherein the sol is an aqueous sol.

26. Coating for solar heating according to claim 24, wherein the metal oxide on which the sol is based is CeO2 (NO3) or CeO2 (ACT) with between 5-30% CeO2 having a particle size of 2-100 nm

27. Coating for solar heating according to claim 24, wherein it is based on a t of two sols.

28. Coating for solar heating according to claim 24, wherein the second sol is a nano scaled Al2O3, SnO2, Y2O3, ZnO or SiO2.

29. Coating for solar heating according to claim 24, wherein the CeO2 is between 15-25%

30. Coating for solar heating according to claim 24, wherein the pigment is a manganese ferrite black (Mn3Cu2FeO8).

31. Coating for solar heating according to claim 24, wherein an organic additive is added and mixed into the sol lacquer immediately prior to application on the substrate and before temperature heat treatment for improving adhesion.

32. Coating for solar heating according to claim 30, wherein the additive is an acrylate- and styrocopolymer, a mixure of polyvinyl acetate polymer and -copolymer, polyvinyl acetate, polyvinyl alcohol, polyvinyl ether, polyurethane and/or polymetacrylathomo and -copolymer, acrylat dispersions, polyester.
